(19) United States
(12) Patent Application Publication
(10) Pub. No.: US 2018/0088546 A1
(43) Pub. Date: Mar. 29, 2018

(54) ROBOT ASSEMBLY DEVICE

(71) Applicant: ROBOTIS CO., LTD., Seoul (KR)

(72) Inventors: Byoung Soo KIM, Seoul (KR); Keun Man JUNG, Anyang-si (KR); In Yong HA, Seoul (KR)

(73) Assignee: ROBOTIS CO., LTD., Seoul (KR)

(21) Appl. No.: 15/273,725

(22) Filed: Sep. 23, 2016

(51) Int. Cl. G05B 17/02; G05B 19/042

(52) U.S. Cl. CPC G05B 17/02; G05B 2219/49007; G05B 19/0426; G05B 19/0423

(57) ABSTRACT

A robot assembling device is provided including a storage configured to store a 3-dimensional (3D) image file with respect to a plurality of components configuring a robot, an identification (ID) with respect to each of a plurality of robot modules operating the plurality of components or related thereto, position information, characteristic information, required voltage information, information on an electrical connection between the plurality of robot modules, and information on an electrical connection the plurality of robot modules and a controller configured to control the plurality of robot modules, and a robot assembly viewer configured to display a 3D image with respect to each of the plurality of components, and display information regarding at least one among the plurality of robot modules, which is connectable to the controller, and information regarding robot modules connectable to each other on an assembly display window using information on an electrical connection.

### TECHNICAL FIELD

The present disclosure relates to a robot assembling device, and more particularly, to a robot assembling device capable of assembling a robot using an electrical connection between constituents configuring a robot.

### BACKGROUND ART

Robots are recently being used in various industries by virtue of development of a robot technology field, and demand for easily producing a robot is growing.

Generally, a robot should be assembled in consideration of not only a mechanical connection configuring the robot but also an electrical connection configuring the robot.

However, only a mechanical connection is conventionally considered when a robot is assembled such that a method of application is limited to a physical aspect after the robot is assembled.

Therefore, a situation in which a method through which a robot may be assembled with much more consideration of an electrical connection between robot modules including a battery, a controller, an actuator module, a sensor module, a communication module, a display module, and the like in addition to physically assembling the robot is urgently needed exists.

### DISCLOSURE

### Technical Problem

To address the above described problem, an object of the present disclosure is to provide a robot assembling device capable of assembling a robot using an electrical connection between constituents configuring the robot.

The object of the present disclosure is not limited to the above described object, and other objects not mentioned above will be apparently understood from the following description.

### Technical Solution

To attain the above described object, in accordance with one embodiment of the present disclosure, a robot assembling device is provided including a storage configured to store a 3-dimensional (3D) image file with respect to a plurality of components configuring a robot, an identification (ID) with respect to each of a plurality of robot modules operating the plurality of components or related thereto, position information, characteristic information, required voltage information, information on an electrical connection between the plurality of robot modules, and information on an electrical connection between the plurality of robot modules and a controller configured to control the plurality of robot modules, and a robot assembly viewer configured to display a 3D image with respect to each of the plurality of components, and display information regarding at least one among the plurality of robot modules that is connectable to the controller and information regarding robot modules connectable to each other on an assembly display window using information on the electrical connection.

The storage may further store information regarding a port formed at one among the plurality of robot modules, information regarding a connector coupled to the port, and information on an electrical connection between the connector and the controller, and the robot assembly viewer may verify a coupling direction of the port, a size thereof, and the number of pins thereof using the information on the electrical connection, determine whether the port and the connector are connectable to each other, display a 3D image in which the connector is coupled to the port on the assembly screen window when it is determined that the port and the connector connectable to be each other, and display a connector connectable to the controller on the assembly display window.

The storage may further store information on an electrical connection between the plurality of robot modules and a battery supplying electricity thereto, and the robot assembly viewer may compare a voltage required for each of plurality of robot modules with a voltage supplied by the battery, and display at least one among the plurality of robot modules that is connectable to the battery on the assembly display window.

The robot assembly viewer may also display the ID assigned to each of the plurality of robot modules on the assembly screen window together with the 3D image with respect to each of the plurality of components displayed on the assembly display window, and, when one or more robot modules are selected, the robot assembly viewer may also display an interface configured to adjust an angle of each of the selected one or more robot modules according to a time, and the storage may further include angle adjustment information according to a time input through the interface.

The robot assembly viewer may also display a video in which a component operated by means of the selected one or more robot modules moves on the assembly screen window using the angle adjustment information.

### Advantageous Effects

In accordance with one embodiment of the present disclosure, a robot module connectable to a controller or a battery is displayed on a screen window so that there is an effect in which a relationship between constituents of a robot, which are connected to each other according to an electrical characteristics thereof, may be understood as well as a mechanical connection thereof.

Also, in accordance with one embodiment of the present disclosure, an interface through which an angle of a robot module may be adjusted according to a time is provided so that a simulation video in which a robot moves may be easily provided.

The effects of the present disclosure are not limited to the described above, and it should be understood that all deducible effects from a description herein or a configuration defined by the appended claims may be included.

### DESCRIPTION OF DRAWINGS

FIG. 1 is a block diagram illustrating a configuration of a robot assembling device according to one embodiment of the present disclosure;

FIG. 2 is a diagram illustrating an assembly screen window displaying a robot according to one embodiment of the present disclosure;

FIG. 3 is a diagram illustrating an assembly screen window displaying constituents configuring a robot according to one embodiment of the present disclosure; and

FIG. 4 is a diagram illustrating an assembly screen window displaying a robot according to another embodiment of the present disclosure.

### MODES OF THE INVENTION

Hereinafter, the present disclosure will be described with reference to the accompanying drawings. However, the present disclosure may be implemented in various different forms, and thus is not limited to embodiments that will be described herein. Also, in the accompanying drawings, parts not related to description will be omitted in order to clearly describe the present disclosure, and the same or similar reference numerals are given to components having the same or similar functions throughout the disclosure.

Throughout the disclosure, it should be understood that when a part is described as “connected” to another part, a case in which the part is “directly connected” to the other part as well as a case in which the part is “indirectly connected” thereto by interposing another member between the part and the other part are included. Also, when a constituent is described as “including” another constituent in the present application, this description does not preclude the presence thereof and should be understood as being able to further include other constituents unless there is clearly a different meaning.

Hereinafter, embodiments of the present disclosure will be described in detail with reference to the accompanying drawings.

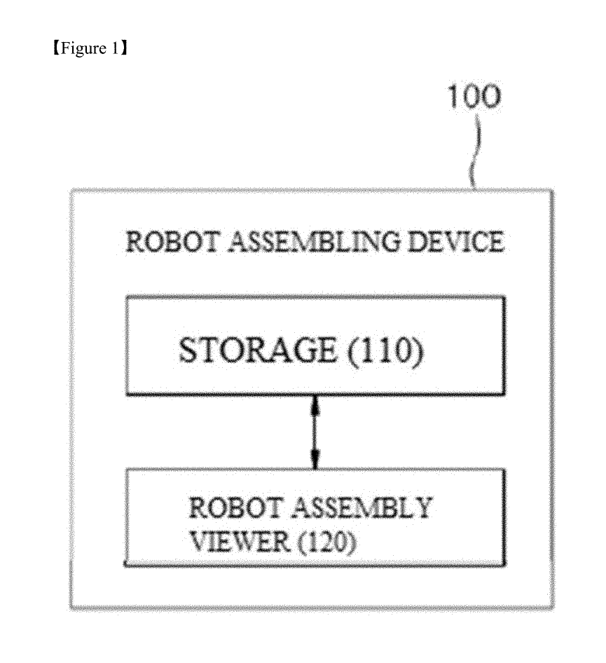

FIG. 1 is a block diagram illustrating a configuration of a robot assembling device according to one embodiment of the present disclosure.

Referring to FIG. 1, a robot assembling device 100 according to one embodiment of the present disclosure may include a storage 110 and a robot assembly viewer 120.

The storage 110 may be configured with a memory of the robot assembling device 100, which includes a program memory, a data memory, and the like.

Execution programs executed by means of the robot assembly viewer 120 may be stored in the program memory. For example, the storage 110 may store a first program capable of editing a connection between robot modules and information corresponding thereto, a second program capable of controlling each of the robot modules, and the like in the program memory.

Data which is generated while the programs stored in the program memory are executed by means of the robot assembly viewer 120 may be stored in the data memory. For example, the storage 110 may store information on an electrical connection between a robot module and a controller, information on an electrical connection between a robot module and a battery, information on an electrical connection between robot modules, and the like, which are generated by the first program and a simulation video, in which a robot moves, which is generated through the second program.

The robot assembling device 100 may execute the first program and the second program by interlocking them, and may load information, which is generated through the first program, into the second program. That is, the robot assembling device 100 may load information regarding a robot, of which a connection between constituents of the robot is edited through the first program, into the second program, and provide a simulation video in which a corresponding operation of the robot is controlled.

The storage 110 may store a 3-dimensional (3D) image file with respect to various constituents of a robot. For example, the storage 110 may store a 3D image file with respect to the various constituents of a robot including a plurality of components configuring the robot, a plurality of robot modules operating the components or related thereto, a port formed at each of the robot modules, a connector coupled to the port, and the like.

Here, each of the robot modules may include an actuator module for operating the components, a communication module for communicating with an external device, a sensor module for sensing a surrounding situation to acquire information, and a display module for displaying the information, but the modules are not limited thereto and may include various modules required for configuring a robot.

The storage 110 may store an identification (ID) assigned to each of the plurality robot modules, position information of each thereof, characteristic information of each thereof, and information on a voltage required for operating each thereof.

The storage 110 may store information on an electrical connection between at least one robot module and a controller. Here, the electrical connection information is information that represents a connection method in which a controller controlling the robot modules is connected to the robot modules controlled by the controller, thereby informing whether the robot modules and the controller are connected or are connectable to each other, and the electrical connection information may include information on an electrical connection between a single controller and a single robot module and between a single controller and a plurality of robot modules.

The storage 110 may store information on an electrical connection between at least one robot module and a battery. Here, the electrical connection information is information that represents a connection method in which a battery supplying electricity to the robot modules is connected to the robot modules receiving the electricity supplied by the battery, thereby informing whether the robot modules and the battery are connected or are connectable to each other, and may include information on an electrical connection between a single battery and one or more robot modules.

The storage 110 may store information on an electrical connection between the plurality of robot modules. Here, the electrical connection information is information that represents a connection method in which the plurality of robot modules are connected to each other, thereby informing whether the plurality of robot modules are connected or are connectable to each other, and may include information on an electrical connection between one of the plurality of robot modules and at least one other robot module.

The storage 110 may store information regarding a port formed at one of the plurality of robot modules, information regarding a connector coupled to a port corresponding thereto, and information on an electrical connection between the connector and a controller. Here, the electrical connection information is information that represents a connection method in which the connector and the controller transmitting a control signal through the connector are connected to each other, thereby informing whether the connector and the controller are connected or are connectable to each other, and may include information on an electrical connection between a single controller and one or more connectors.

The storage 110 may store angle adjustment information according to a time, which is used for adjusting a robot module angle displayed by means of the robot assembly viewer 120 according to the time input through an interface. This will be described below with reference to FIG. 4.

The robot assembly viewer 120 may display a variety of information on an assembly screen window that is provided through the first program. At this point, the robot assembly viewer 120 may display information through one or more assembly display windows, and, when displaying information through a plurality of assembly display windows, the robot assembly viewer 120 may display the information by dividing each of the plurality of assembly display windows or overlapping the plurality of assembly display windows with each other.

The robot assembly viewer 120 may display a 3D image file, which is stored in the storage 110, with respect to the various constituents of a robot on the assembly display window. At this point, the robot assembly viewer 120 may separately display a 3D image with respect to each of a plurality of constituents on the assembly display window, and may display a 3D image, which is a combination of the plurality of constituents, with respect to the entire robot or a portion thereof.

The robot assembly viewer 120 may display 3D images with respect to the various constituents of the robot on the assembly display window, and, when a screen window change command (for example, a move command, a zoom in command, a zoom out command, or the like) is input according to a manipulation of a user, a 3D image changed according to the screen window change command may also be displayed on the assembly display window.

Using the information on the electrical connection between the robot module and the controller stored in the storage 110, the robot assembly viewer 120 may display one or more robot modules connected or connectable to the controller on the assembly display window.

That is, when a controller is selected according to a manipulation of a user, the robot assembly viewer 120 may display one or more robot modules connected or connectable to the selected controller, and, when a robot module is selected according to a manipulation of the user, the robot assembly viewer 120 may display a controller connected or connectable to the selected robot module.

While displaying the 3D images with respect to the various constituents of the robot, the robot assembly viewer 120 may separately display one or more robot modules connected or connectable to the controller on a new assembly display window, and may emphatically display the one or more robot modules connected to the controller on the new assembly screen window (for example, by making the corresponding constituent blink or illustrating it in a different color).

The robot assembly viewer 120 may verify a voltage of a robot module using voltage information stored in the storage 110, and may determine whether the robot module is connectable to a battery to display connection possibility on the assembly display window. At this point, the robot assembly viewer 120 may determine whether the robot module is connectable to the battery by comparing a voltage required for the robot module to operate with a voltage supplied by the battery.

Also, using the information on the electrical connection between the robot module and the battery stored in the storage 110, the robot assembly viewer 120 may separately display one or more robot modules connected or connectable to the battery, and emphatically display the one or more robot modules connected to the battery.

The robot assembly viewer 120 may display one or more robot modules connected or connectable to a specific robot module on the assembly screen window using the information on the electrical connection between the robot modules stored in the storage 110.

For example, when a first robot module and a second robot module are set as being connectable, the robot assembly viewer 120 may display the second robot module that is connectable to the first robot module when the first robot module is selected according to a manipulation of a user, and may display the first robot module that is connectable to the second robot module when the second robot module is selected according to a manipulation of the user.

When the first robot module and the second robot module are set to be connected to each other, the robot assembly viewer 120 may display the second robot module connected to the first robot module when the first robot module is selected, and may display the first robot module connected to the second robot module when the second robot module is selected like the case described above.

The robot assembly viewer 120 may display a port formed at each of the robot modules and a connector coupled to a port on the assembly screen window using port information and connector information which are stored in the storage 110. At this point, while displaying 3D images with respect to the various constituents of the robot on the assembly display window, the robot assembly viewer 120 may display a region on which the port or the connector is displayed according to a manipulation command of the user or by automatically enlarging the region.

When displaying the port and the connector, the robot assembly viewer 120 may verify a coupling direction of the port, a size thereof, and the number of pins thereof using the port information, may determine whether the port and the connector are connectable to each other, and may display a 3D image in which the port and the connector are connected to each other on the assembly display window when it is determined that the port and the connector are connectable to each other. At this point, the robot assembly viewer 120 may determine whether a corresponding port and a corresponding connector are connectable to each other by comparing the number of pins of the corresponding port with the number of pins of the corresponding connector.

The robot assembly viewer 120 may display one or more connectors connected or connectable to the controller on the assembly screen window using information on an electrical connection between the controller and the connector stored in the storage 110.

The robot assembly viewer 120 may display the 3D images with respect to the various constituents of the robot through the first program on the assembly display window, and may also display the ID assigned to each of the plurality of robot modules, which is stored in the storage 110.

When one or more robot modules are selected among the plurality of robot modules, the robot assembly viewer 120 may display an interface for adjusting the selected one or more robot modules on the assembly screen window through the second program by executing the second program, and may also display a video in which a component operated by a robot module using the angle adjustment information stored in the storage 110 moves on the assembly display window. This will be described below with reference to FIG. 4.

FIG. 2 is a diagram illustrating an assembly screen window displaying a robot according to one embodiment of the present disclosure.

Firstly, the robot assembly viewer 120 may display 3D images, which are stored in the storage 110, with respect to various constituents of a robot on the assembly display window.

Referring to FIG. 2, the robot assembly viewer 120 may display an overall 3D image of the robot including a first robot module 201, a second robot module 202, a controller 203, and a battery 204. Here, each of the first robot module 201 and the second robot module 202 may be one among various robot modules including an actuator module, a communication module, a sensor module, a display module, and the like.

In addition to the overall 3D image of the robot, the robot assembly viewer 120 may display a 3D image of a portion of the robot, and also may separately display a 3D image with respect to a single constituent among the various constituents of the robot.

For example, while displaying the overall 3D image of the robot, the robot assembly viewer 120 may display a portion of the robot by enlarging a leg portion thereof when a command for enlarging the leg portion of the robot is input. The robot assembly viewer 120 may also display detailed information regarding the controller 203 (for example, information regarding robot modules controlled by the controller 203) while separately displaying a 3D image with respect to the controller 203 when the controller 203 is selected among the various constituents of the robot, and may also display detailed information (for example, information of robot modules connected to the battery 204, voltage information of electricity supplied by the battery 204, and the like) regarding the battery 204 while separately displaying a 3D image with respect to the battery 204 when the battery 204 is selected.

The controller 203 and the battery 204 may be connected to one or more robot modules, and hereinafter, it is assumed that the controller 203 may be connected to the first robot module 201 and the second robot module 202, and the battery 204 may be connected to the first robot module 201 and the second robot module 202.

The storage 110 may store position information on the first robot module 201 and the second robot module 202. For example, the storage 110 may store position information informing that the first robot module 201 is located at a left side of the controller 203, the second robot module 202 is located at a right side thereof, and the battery 204 is located below the controller 203.

As shown in FIG. 2, while displaying the overall 3D image of the robot which is stored in the storage 110, the robot assembly viewer 120 may emphatically display the controller 203 when the controller 203 is selected according to a manipulation of the user, and may also emphatically display the first robot module 201 and the second robot module 202 which are connectable to the controller 203. At this point, the robot assembly viewer 120 may emphatically display the controller 203, the first robot module 201, and the second robot module 202 through a method of making them blink or illustrating them in a color different from other constituents.

When a connection command between the controller 203 and the first robot module 201 is input according to a manipulation of the user, the robot assembly viewer 120 may determine whether the controller 203 and the first robot module 201 are connected to each other using information on an electrical connection between the controller 203 and the first robot module 201 stored in the storage 110 and display the determination result on the assembly display window. At this point, a connection command between the plurality of robot modules, which include the first robot module 201 and the second robot module 202, and the controller 203 may be input according to a manipulation of the user, and the robot assembly viewer 120 may determine whether the controller 203 and the plurality of robot modules are connected to each other using information on an electrical connection between the controller 203 and the plurality of robot modules stored in the storage 110 and display the determination result on the assembly display window.

When it is determined that the controller 203 and the first robot module 201 are connectable to each other, the storage 110 may change the information on the electrical connection between the controller 203 and the first robot module 201. That is, the storage 110 may change and store the information on the electrical connection between the controller 203 and the first robot module 201 from “connectable” to “connection completed.”

The robot assembly viewer 120 may emphatically display the controller 203 and one or more robot modules connected thereto through a method of illustrating them in the same color using the information on the electrical connection between the controller 203 and the robot modules. Through such an operation, the user may be informed that the one or more robot modules which are connected and substantially controlled by the controller 203.

For example, when a connection among the controller 203, the first robot module 201, and the second robot module 202 is completed, the storage 110 may change and store information on an electrical connection among the controller 203, the first robot module 201, and the second robot module 202 to “connection completed,” and the robot assembly viewer 120 may display the first robot module 201 and the second robot module 202, which are connected to the controller 203, in a color that is the same as that of the controller 203 when the controller 203 is selected according to a manipulation of the user, and may display the controller 203 controlling the first robot module 201, and the second robot module 202, which is another robot module connected to the controller 203, in a color that is the same as that of the first robot module 201 when the first robot module 201 is selected.

The storage 110 may store voltage information regarding each of the constituents, which includes the voltage information of the electricity supplied by the battery 204, voltage information regarding a voltage required for the first robot module 201 to operate components, voltage information regarding a voltage required for the second robot module 202 to operate components, and the like.

As shown in FIG. 2, while displaying the overall 3D image of the robot, the robot assembly viewer 120 may emphatically display the battery 204 when the battery 204 is selected according to a manipulation of the user, and may also emphatically display the first robot module 201 and the second robot module 202, which are connectable to the battery 204.

When a connection command between the battery 204 and the first robot module 201 is input according to a manipulation of the user, the robot assembly viewer 120 may verify a voltage of each of the battery 204 and the first robot module 201 using information on an electrical connection between the battery 204 and the first robot module 201 stored in the storage 110 and determine whether the battery 204 and the first robot module 201 are connectable to each other based on the verified voltage to display connection possibility. At this point, a connection command between the plurality of robot modules, which include the first robot module 201 and the second robot module 202, and the battery 204 may be input according to a manipulation of the user, and the robot assembly viewer 120 may verify a voltage of each of the battery 204 and the plurality of robot modules and determine whether the battery 204 is connectable to each of the plurality of robot modules, thereby displaying connection possibility.

For example, the storage 110 may store battery information that a voltage of the battery 204 is 5 volts (V), a voltage of the first robot module 201 is 5V, and a voltage of the second robot module 202 is 10V. At this point, when a connection command among the battery 204, the first robot module 201, and the second robot module 202 is input according to a manipulation of the user, the robot assembly viewer 120 may determine that only the battery 204 and the first robot module 201, which use the same voltage of 5V, are connectable to each other and display the first robot module 201 and the battery 204 in the same color and a connection impossible message with respect to the second robot module 202 due to a voltage difference.

When the battery 204 and the first robot module 201 are connected to each other, the storage 110 may change and store the information on the electrical connection between the battery 204 and the first robot module 201 from “connectable” to “connection completed.”

Meanwhile, the plurality of robot modules may be connected to each other, and it is assumed that the first robot module 201 and the second robot module 202 may be connected to each other and that the first robot module 201 may not be connected to a third robot module except the first robot module 201 and the second robot module 202.

When the first robot module 201 is selected according to a manipulation of the user, the robot assembly viewer 120 may also emphatically display the second robot module 202 that is connectable to the first robot module 201 while emphatically displaying the first robot module 201. At this point, the robot assembly viewer 120 may display the third robot module, which cannot be connected to the first robot module 201, in a color different from that of the first robot module 201 and the second robot module 202, thereby informing the user that the third robot module cannot be connected to the first robot module 201.

When a connection command between the first robot module 201 and the third robot module is input according to a manipulation of the user, the robot assembly viewer 120 may determine connection possibility between the first robot module 201 and the third robot module using information on an electrical connection between the first robot module 201 and the third robot module stored in the storage 110 and display the determination result on the assembly display window. At this point, because the first robot module 201 and the third robot module are not connectable to each other, the robot assembly viewer 120 may display the determination result together with the second robot module 202 that is a connectable robot module, thereby recommending a robot module that is connectable to the first robot module 201.

When a connection command between the first robot module 201 and the second robot module 202 is input according to a manipulation of the user, the storage 110 may change and store the information on the electrical connection between the first robot module 201 and the second robot module 202 from “connectable” to “connection completed.”

As described above, in accordance with one embodiment of the present disclosure, a robot module connected to the controller 203 and the battery 204 is displayed on a screen window so that there is an effect in which a relationship between constituents connected to each other according to electrical characteristics thereof may be understood as well as a mechanical connection thereof.

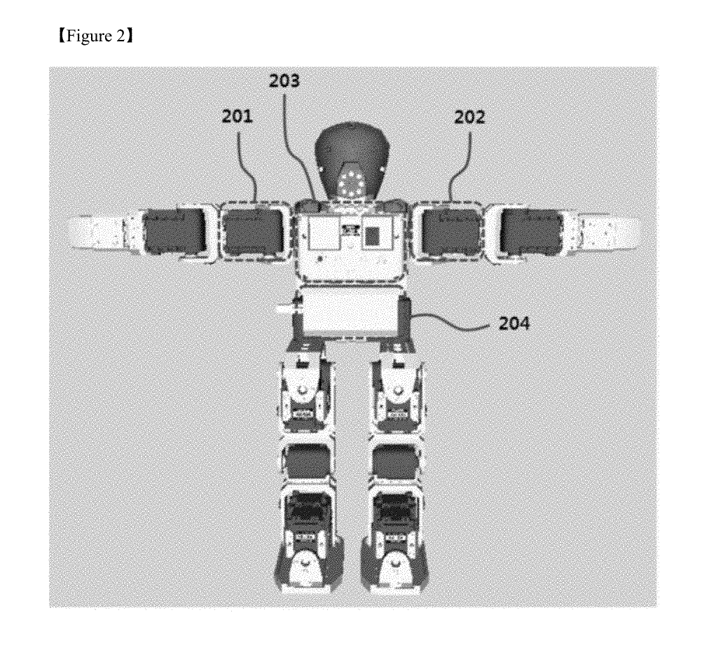

FIG. 3 is a diagram illustrating an assembly screen window displaying components configuring a robot according to one embodiment of the present disclosure.

In FIG. 2, the robot assembly viewer 120 displays the overall 3D image of the robot, and, when a screen window enlarging command is input or a specific component is selected according to a manipulation of the user, the robot assembly viewer 120 may display a 3D image of a portion of the robot as shown in FIG. 3.

Referring to FIG. 3, the robot assembly viewer 120 may display a 3D image of a component that is a portion of a robot including a first port 301 and a first connector 302 connected to a second port. Here, the first port 301 and the second port may be included in the same robot module or in different robot modules. The first port 301 is in a state in which a connector is not connected thereto, and the second port may be included in the first connector 302 in a state in which the second port is coupled to the first connector 302 shown in FIG. 3.

A connector may be coupled to a port to transmit an electrical signal between robot modules and supply electric power therebetween, and the first connector 302 shown in FIG. 3 may serve to transmit information between a robot module including the second port and a robot module including a coupled port except the second port.

The storage 110 may store information regarding the first port 301 formed at a robot module and the first connector 302 coupled to the second port, and the robot assembly viewer 120 may display the first port 301 and the first connector 302 coupled to the second port using electrical connection information stored in the storage 110.

In particular, the robot assembly viewer 120 displays robot modules configuring the robot, and may also display the first port 301 included in a robot module when the first port 301 is included in the robot module.

As described above, the robot assembly viewer 120 may also display the second port when the second port is included in a component, and may determine whether the second port and the first connector 302 are connectable to each other using electrical connection information and display a 3D image in which the first connector 302 is coupled to the second port when it is determined that the second port and the first connector 302 are connectable to each other.

At this point, the robot assembly viewer 120 may determine whether the second port and the first connector 302 are connectable to each other by verifying the number of pins of the second port and the number of pins of the first connector 302. For example, the storage 110 may store electrical connection information in which the number of pins of the second port is 5 and the number of pins of the first connector 302 is 5. Consequently, the robot assembly viewer 120 may verify the number of pins of the second port and the number of pins of the first connector 302 using the electrical connection information, and determine that the second port and the first connector 302 are connectable to each other because the number of pins of the second port and the number of pins of the first connector 302 are the same, thereby displaying the 3D image in which the second port and the first connector 302 are coupled to each other. When determining whether coupling is possible, the robot assembly viewer 120 may determine whether a port and a connector are couplable to each other by verifying a size of the port, a coupling direction thereof, and the like in addition to the number of pins of the port.

When the first connector 302 is selected, the robot assembly viewer 120 may also display another port that is connectable to the first connector 302. For example, when the number of pins of the first port 301 and the number of pins of the first connector 302 are 5, which is the same, the robot assembly viewer 120 may display the first connector 302 and the first port 301 in the same color, thereby informing the user that the first connector 302 and the first port 301 are connectable to each other. Meanwhile, the controller 203 may be connected to one or more connectors, and hereinafter, it is assumed that the controller 203, the first connector 302, and a second connector may be connected to each other.

When the controller 203 is selected according to a manipulation of the user, the robot assembly viewer 120 may display a connector list including the first connector 302 and the second connector which are connectable to the controller 203.

When the first connector 302 is selected from the connector list, the storage 110 may recognize that a connection command between the controller 203 and the first connector 302 is input and change information on an electrical connection between the controller 203 and the first connector 302 from “connectable” to “connection connected” and store the electrical connection information.

Thereafter, when the controller 203 is selected, the robot assembly viewer 120 may inform the user that the controller 203 and the first connector 302 are connected to each other through a method of displaying the first connector 302 connected to the controller 203 and the first connector 302 in the same color using the electrical connection information.

Also, when the controller 203 is selected, the robot assembly viewer 120 may inform the user that the controller 203 and the second connector are connectable to each other through a method of displaying the second connector in a color different from that of other constituents.

Meanwhile, the storage 110 may store an ID assigned to each of ports and information regarding a robot module connected to each of the ports.

For example, the robot assembly viewer 120 may display a port list including the first port 301 and the second port on the assembly display window, and may display “1,” which is the ID assigned to the first port 301, and a robot module connected to the first port 301 on the assembly display window when the first port 301 is selected from the port list.

As described above, in accordance with one embodiment of the present disclosure, a component including a port and a connector may be displayed on a screen window so that a relationship between constituents that are connected to each other according to electrical characteristics thereof may be easily understood.

FIG. 4 is a diagram illustrating an assembly screen window displaying a robot according to another embodiment of the present disclosure.

The storage 110 may store a 3D image file with respect to various constituents of a robot, and may also store an ID assigned to each of robot modules among the various constituents. Here, the ID may be assigned according to a manipulation command of the user, or may be arbitrarily assigned by means of the robot assembling device 100.

Referring to FIG. 4, the robot assembly viewer 120 may display 3D images, which are stored in the storage 110, with respect to the various constituents of the robot on the assembly display window, and may also display the ID assigned to each of the robot modules thereon.

When one or more IDs among the IDs displayed on the assembly screen window are selected according to a manipulation of the user, the robot assembly viewer 120 may display an interface for adjusting an angle of a selected robot module according to a time, and the storage 110 may store angle adjustment information according to the time, which is input through the displayed interface. Here, the angle adjustment information is information that represents at what time and how much an angle of the selected robot module is adjusted through the interface.

For example, when the user selects a robot module corresponding to an ID of 15 through the interface and, after two seconds, inputs angle adjustment information for adjusting an angle of the robot module by 30 degrees, the storage 110 may store the input angle adjustment information. At this point, the user may separately set an angle adjustment for each of the robot modules, or may set the plurality of robot modules as a group to adjust an angle with respect to the group.

The storage 110 may store characteristic information regarding each of the robot modules. Here, the characteristic information regarding each of the robot modules may be information regarding an angle range in which a corresponding robot module is adjustable.

For example, the storage 110 may store information regarding an angle in a range of 0 to 90 degrees as characteristic information of a robot module corresponding to an ID of 11, and the robot assembly viewer 120 may display an interface in which an angle may be adjusted in the range of 0 to 90 degrees. The reason for this is that a characteristic with respect to an angle range per robot module is set in advance to limit a movable range of a corresponding robot module because an adjustable angle with respect to each of the robot modules is different (for example, a movable angle range of an arm portion is different from that of a leg portion).

The storage 110 may verify whether the angle adjustment information according to a time input through the interface is suitable, and then store the angle adjustment information using the characteristic information of the robot module. For example, when the characteristic information of the robot module corresponding to the ID of 11 is information with respect to the angle range from 0 to 90 degrees, the storage 110 may verify whether angle adjustment information of the robot module corresponding to the ID of 11 is within 0 to 90 degrees, and then store the angle adjustment information.

The robot assembly viewer 120 may generate a video in which a component operated by means of a robot module moves, that is, a simulation video in which the robot moves using the angle adjustment information stored in the storage 110, and display the video on the assembly display window.

For example, when the user inputs angle adjustment information for changing an angle of each of robot modules corresponding to IDs of 3 and 4 to 90 degrees after two seconds through an interface, the robot assembly viewer 120 may adjust an angle of each of the robot modules corresponding to the IDs of 3 and 4 by 90 degrees after two seconds and move components operated by means of the robot modules corresponding to IDs of 3 and 4, thereby displaying a video in which both arms of the robot are raised on the assembly display window.

An operational control of each of the robot modules, which has been described with reference to FIG. 4, may be performed by the second program, and a connection between constituents and a storing of corresponding information which are described with reference to FIGS. 2 and 3 may be performed by the first program.

That is, the storage 110 may store information on an electrical connection between constituents, which is generated through the first program, in a form of a specific file (for example, an extensible markup language (XML) file), and the robot assembly viewer 120 may load the stored file into the second program and control an operation of the robot, which is set through the first program, through the second program to provide a simulation video of the robot.

As described above, in accordance with the present disclosure, an interface through which an angle of each of the robot modules may be adjusted according to a time is provided so that a simulation video in which a robot moves may be easily provided.

Description of the present disclosure has been illustratively provided, and it should be understood that numerous other modifications and embodiments can be easily devised by those skilled in the art without changing the technical spirit or essential features of the present disclosure. Therefore, the embodiments disclosed herein should be understood as a number of illustrative embodiments of the present disclosure which is not limited thereto. For example, each constituent described as a single form may be performed in a distributed manner, and similarly, constituents described to be distributed may be performed as a combined form.

The scope of the present disclosure should be represented by the appended claims, and it should be understood that modifications or other embodiments derived from the meaning, range, and equivalents of the appended claims are included in the scope of the present disclosure.

### DESCRIPTION OF SYMBOLS

100: robot assembling device

110: storage

120: robot assembly viewer

201: first robot module

202: second robot module

203: controller

204: battery

301: first port

302: first connector

1. A robot assembling device, comprising:
a storage configured to store a 3-dimensional (3D) image file with respect to a plurality of components configuring a robot, an identification (ID) with respect to each of a plurality of robot modules operating the plurality of components or related thereto, position information, characteristic information, required voltage information, information on an electrical connection between the plurality of robot modules, and information on an electrical connection between the plurality of robot modules and a controller configured to control the plurality of robot modules; and
a robot assembly viewer configured to display a 3D image with respect to each of the plurality of components, and display information regarding at least one among the plurality of robot modules, which is connectable to the controller, and information regarding robot modules connectable to each other on an assembly display window using information on the electrical connection.

2. The robot assembling device of claim 1, wherein the storage further stores information regarding a port formed at one among the plurality of robot modules, information regarding a connector coupled to the port, and information on an electrical connection between the connector and the controller, and
the robot assembly viewer verifies a coupling direction of the port, a size thereof, and the number of pins thereof using the information regarding the port, determines whether the port and the connector are connectable to each other, displays a 3D image in which the connector is coupled to the port on the assembly screen window when it is determined that the port and the connector are connectable to each other, and displays a connector connectable to the controller on the assembly display window.

3. The robot assembling device of claim 1, wherein the storage further stores information on an electrical connection between the plurality of robot modules and a battery supplying electricity thereto, and
the robot assembly viewer compares a voltage required for operating each of the plurality of robot modules with a voltage supplied by the battery, and displays at least one among the plurality of robot modules, which is connectable to the battery, on the assembly display window.

4. The robot assembling device of claim 1, wherein the robot assembly viewer also displays the ID assigned to each of the plurality of robot modules on the assembly screen window together with the 3D image with respect to each of the plurality of components displayed on the assembly display window, and, when one or more robot modules are selected, the robot assembly viewer also displays an interface configured to adjust an angle of each of the selected one or more robot modules according to a time, and
the storage further includes angle adjustment information according to a time input through the interface.

5. The robot assembling device of claim 4, wherein the robot assembly viewer also displays a video in which a component operated by means of the selected one or more robot modules moves on the assembly screen window using the angle adjustment information.
